(19) United States
(12) Patent Application Publication
(10) Pub. No.: US 2009/0234058 A1
(43) Pub. Date: Sep. 17, 2009

(54) AQUEOUS INK COMPOSITION

(75) Inventor: Misato Sasada, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/402,658

(22) Filed: Mar. 12, 2009

(30) Foreign Application Priority Data
Mar. 14, 2008 (JP) 2008-066355

(51) Int. Cl. C08K 3/04

(52) U.S. Cl. 524/495

(57) ABSTRACT

An aqueous ink composition including a carbon black having a specific surface area of 200 m²/g or more but less than 300 m²/g according to a BET method, an organic solvent, a neutralizing agent and water, wherein the carbon black is coated with a water-insoluble resin including a structural unit represented by the following formula (I):

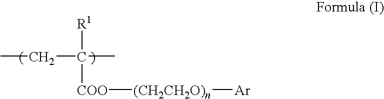

wherein R¹ represents a hydrogen atom or a methyl group, Ar represents an unsubstituted or substituted aromatic ring, and n represents an average repeating number and is from 1 to 6.

### CROSS-REFERENCE TO RELATED APPLICATION

This application claims priority under 35 USC 119 from Japanese Patent Application No. 2008-066355, the disclosure of which is incorporated by reference herein.

### BACKGROUND OF THE INVENTION

1. Field of the Invention

The present invention is related to an aqueous ink composition in which carbon black is used as a colorant.

2. Description of the Related Art

With respect to a recording medium for inkjet recording and ink used therefore, various technologies are being studied to obtain a high quality recorded material excellent in color density, ink fixing property and resolution.

As a colorant used in ink for inkjet recording, pigments are widely used from the view point of obtaining resistance to light and resistance to water, etc. In addition, in a recording liquid for an inkjet printer, carbon black is generally used as a pigment for black ink.

However, when carbon black is used, it is difficult to obtain high definition and a good coloring property unless carbon black is finely and stably dispersed. In particular, with respect to a recording liquid for an inkjet printer, presence of pigment particles that are insufficiently dispersed is directly related to the problem of clogging of a nozzle in a discharge head. However, since carbon black has a fine primary particle diameter and has a strong tendency of secondary aggregation, extensive studies are required to achieve a fine dispersion and also stably maintain the particle diameter thereof.

Under such circumstances, as a carbon black pigment which can be used for aqueous ink for inkjet recording, an aqueous dispersion for inkjet recording including a carbon black pigment coated with a water-insoluble polymer has been suggested (for example, see Japanese Patent Application Laid-Open (JP-A) No. 2007-169506). According to this document, it is described that the dispersion is excellent in image density, image uniformity and the like.

However, according to the above aqueous dispersion for inkjet recording, the specific surface area of the carbon black is not sufficient so that it is not satisfactory in terms of the density of the black color. In addition, for example in a case in which finer particles are desired, etc., it is difficult to stably maintain the dispersed particle diameter after the fine dispersion is formed.

Recently, for black ink, ink with a higher print density than conventional one is required. However, currently it is difficult to guarantee discharge stability while carbon black having a large specific surface area, i.e., small particle diameter, is stably dispersed, and such problems are not successfully solved by prior techniques.

In addition, when an image is recorded, sometimes failure in discharge directivity is caused due to adhesion and drying of an aggregate near a head due to occurrence of mist during discharge of liquid droplets. Since such an aggregate is not easily removed by newly discharged liquid, and the removability of the adhered aggregate (i.e., maintainability) is insufficient, problems such as white spots in a recorded image may be caused.

### SUMMARY OF THE INVENTION

According to an aspect of the invention, there is provided an aqueous ink composition comprising a carbon black having a specific surface area of 200 m²/g or more but less than 300 m²/g according to a BET method, an organic solvent, a neutralizing agent and water, wherein the carbon black is coated with a water-insoluble resin comprising a structural unit represented by the following formula (I):

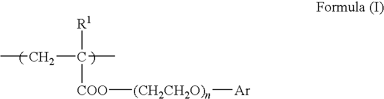

wherein R¹ represents a hydrogen atom or a methyl group, Ar represents an unsubstituted or substituted aromatic ring, and n represents an average repeating number and is from 1 to 6.

### DETAILED DESCRIPTION OF THE INVENTION

The invention has been completed based on the findings that, when a relationship between a structure of a water-insoluble resin and a physical property of carbon black falls within a specific range, dispersibility of carbon black pigment, liquid stability after preparing an ink composition, and a discharge stability during discharge of liquid droplets can be maintained while a high print density is obtained.

Herein below, the aqueous ink composition of the invention will be explained in greater detail.

The aqueous ink composition of the invention includes at least carbon black having a specific surface area of 200 m²/g or more but less than 300 m²/g according to a BET method, which is coated with a water-insoluble resin including a structural unit represented by the formula (I) below (herein below, sometimes referred to as “resin coated carbon black”), an organic solvent, a neutralizing agent, and water, and if necessary, it can further include other components such as resin particles, a polymer latex or a surfactant.

In the invention, by coating a carbon black having a large specific surface area in a range of 200 m²/g or more but less than 300 m²/g (i.e., having a small pigment particle diameter) with a water-insoluble resin having a specific structure, the dispersibility and the dispersion stability after dispersion are well maintained, and the discharge stability at the time of recording as well as print density can be improved. Further, at the time of recording, the adhesion or deposition of the aggregate of the aqueous ink composition at a nozzle of a discharge head can be reduced, and the aggregate can be easily removed even when adhered on a nozzle. As a result, an image with high black color density can be obtained, and failure in ink discharge directivity at the time of discharging ink is inhibited, and the occurrence of an image problem such as white spots, etc. is inhibited, so that a high resolution image can be achieved. Still further, frequency of maintenance of a discharge apparatus can be lowered and also the maintainability can be improved.

—Resin Coated Carbon Black—

The aqueous ink composition of the invention includes at least one carbon black which is coated with a water-insoluble resin (resin coated carbon black), the water-insoluble resin including a structural unit represented by the formula (I) below (herein below, sometimes referred to as a “water-insoluble resin of the invention”). In the resin coated carbon black of the invention, the entire pigment surface is not necessarily coated with the water-insoluble resin of the invention, and at least part of the pigment surface may be coated with the resin.

The carbon black that is included in the aqueous ink composition of the invention is an encapsulated pigment which is at least partially coated with the water-insoluble resin of the invention, i.e., a resin coated pigment particles wherein the pigment particles are included in polymer particles. More specifically, by covering the particle surface of carbon black with the water-insoluble resin, a resin film is formed on at least a part of the surface of carbon black pigment, and the coated particles are dispersed in water.

<Structural Unit Represented by the Formula (I)>

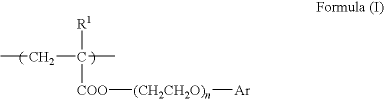

In the formula (I), R¹ represents a hydrogen atom or a methyl group, preferably a methyl group.

Ar represents an unsubstituted or a substituted aromatic ring. When the aromatic ring is substituted, examples of a substituent include, a halogen atom, an alkyl group, an alkoxy group, a hydroxy group, a cyano group and the like, and it may form a condensed ring. When a condensed ring is formed, examples thereof include a condensed aromatic ring having 8 or more carbon atoms, an aromatic ring in which a heterocycle is condensed, and two or more aromatic rings connected to each other.

The “condensed aromatic ring having 8 or more carbon atoms” may be an aromatic ring in which at least two or more benzene rings are condensed, an aromatic ring having 8 or more carbon atoms including at least one aromatic ring and an alicyclic hydrocarbon condensed with the aromatic ring. Specific examples include naphthalene, anthracene, fluorene, phenanthrene, acenaphthene and the like.

The “aromatic ring in which a heterocycle is condensed” may be an aromatic ring wherein an aromatic compound which does not include any hetero atom (preferably a benzene ring) and a cyclic compound which includes a hetero atom is condensed with each other. Herein, the cyclic compound which includes a hetero atom is preferably 5- or 6-membered cyclic compound. As a hetero atom, a nitrogen atom, an oxygen atom or a sulfur atom is preferred. The cyclic compound which includes a hetero atom may include a plurality of hetero atoms. In this case, the hetero atoms may be the same or different from each other. Specific examples of an aromatic ring in which a heterocycle is condensed include phthalimide, acridone, carbazole, benzoxazole, benzothiazole and the like.

The aromatic ring represented by “Ar” is linked to the main chain of the water-insoluble resin via an ester group and an ethyleneoxide chain. Since the aromatic ring is not directly linked to the main chain, an appropriate distance is maintained between the hydrophobic aromatic ring and the hydrophilic structural unit, and an interaction between the water-insoluble resin and the pigment can easily occur, so that the resin is strongly adsorbed to the pigment, and the dispersibility can be improved.

Preferred examples of Ar include an unsubstituted benzene ring and an unsubstituted naphthalene ring. Particularly preferred is an unsubstituted benzene ring.

The symbol “n” represents an average repeating number of an ethyleneoxy chain that is contained in a water-insoluble resin included in the resin coated carbon black included in an aqueous ink composition. The symbol “n” is in the range of 1 to 6, preferably in the range of 1 to 2.

Specific examples of a monomer which forms a structural unit represented by the formula (I) include phenoxyethyl (meth)acrylate and the like, and the following monomers and the like.

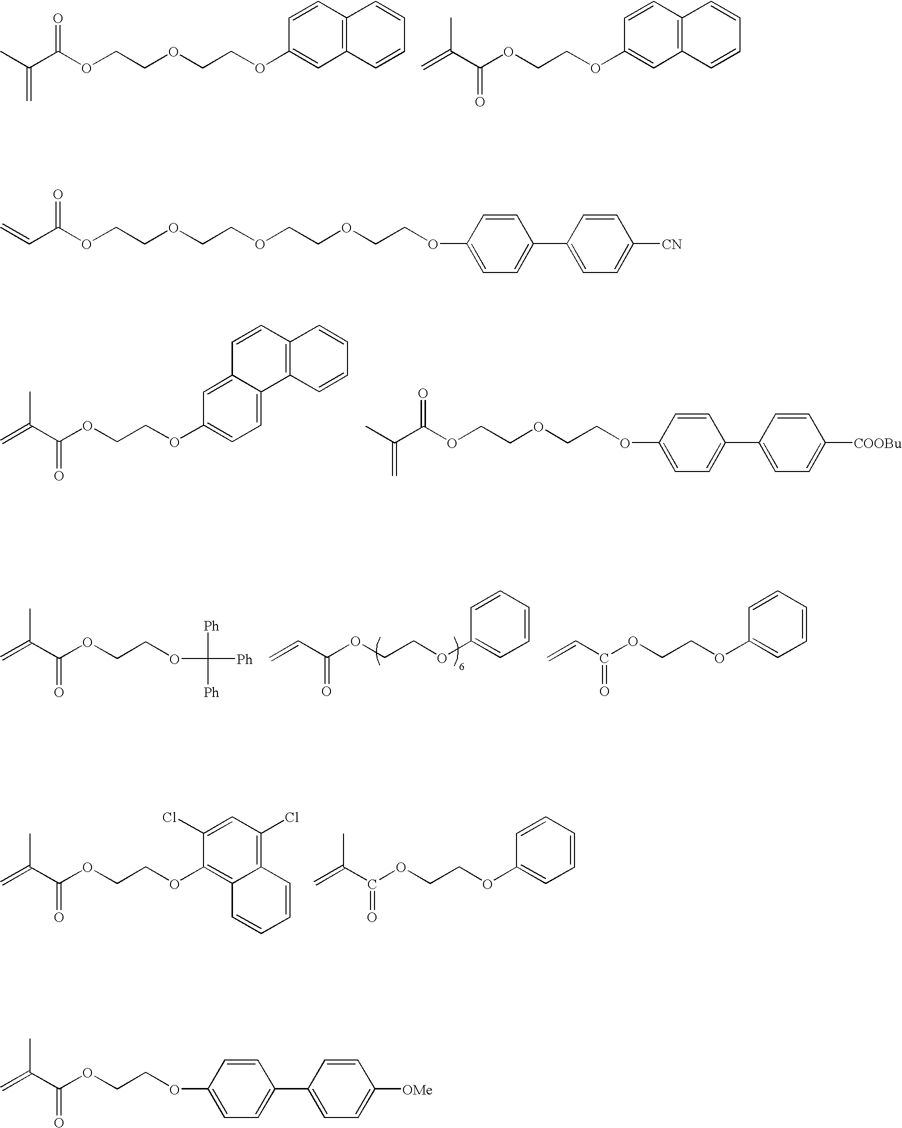

As the structural unit represented by the formula (I), in terms of dispersion stability, a structural unit in which R¹ is a methyl group, Ar is an unsubstituted benzene ring and n is in the range of 1 to 2 is particularly preferred.

The content of a structural unit represented by the formula (I) is preferably 30-70% by mass, and more preferably 40-50% by mass in the water-insoluble resin based on the total mass of the water-insoluble resin. When the content is 30% by mass or more, excellent dispersibility can be obtained. When it is 70% by mass or less, the adhesion and deposition of the aggregate can be inhibited, and the removability of the adhered aggregate (i.e., maintainability) is excellent, so that an image problem such as white spots can be prevented.

The water-insoluble resin of the invention is preferably a resin which includes a hydrophilic structural unit (A) and a hydrophobic structural unit (B), from the view point that it can stably exist in aqueous ink and can reduce adhesion or deposition of aggregate, and also allows easy removal of adhered aggregate. In this case, examples of the hydrophobic structural unit (B) include the structural unit represented by the formula (I).

<Hydrophilic Structural Unit (A)>

As the hydrophilic structure (A), a structural unit derived from acrylic acid or methacrylic acid is preferred. The water-insoluble resin preferably includes at least one of or both the structural unit derived from acrylic acid and the structural unit derived from methacrylic acid. Other examples of the hydrophilic structural unit (A) include a structural unit derived from a monomer having a non-ionic hydrophilic group, such as a vinyl monomer having a hydrophilic functional group, such as (meth)acrylates, (meth)acylamides and vinylesters having a hydrophilic functional group.

Examples of the “hydrophilic functional group” include a hydroxy group, an amino group, an amide group (nitrogen atom is unsubstituted) and alkylene oxides such as polyethylene oxide or polypropylene oxide as described below.

The monomer which forms a hydrophilic structural unit having a non-ionic hydrophilic group is not specifically limited as long as it includes a functional group such as an ethylenic unsaturated bond which can form a polymer and a non-ionic hydrophilic functional group, and it can be selected from known monomers. Specific examples thereof preferably include hydroxyethyl(meth)acrylate, hydroxybutyl(meth)acrylate, (meth)acrylamide, aminoethylacrylate, aminopropylacrylate, and (meth)acrylate which includes an alkylene oxide polymer.

The hydrophilic structural unit (A) which includes a non-ionic hydrophilic group can be formed by polymerization of a corresponding monomer. Alternatively, hydrophilic functional groups may be introduced to the polymer chain after polymerization.

As a hydrophilic structural unit which includes a non-ionic hydrophilic group, a hydrophilic structural unit including an alkylene oxide structure is more preferred. As the alkylene moiety in an alkylene oxide structure, an alkylene moiety having 1 to 6 carbon atoms is preferred, an alkylene moiety having 2 to 6 carbon atoms is more preferred, and an alkylene moiety having 2 to 4 carbon atoms is even more preferred, in terms of hydrophilicity. In addition, the polymerization degree of the alkylene oxide structure is preferably 1 to 120, more preferably 1 to 60 and even more preferably 1 to 30.

In addition, as a hydrophilic structural unit which includes a non-ionic hydrophilic group, a hydrophilic structural unit including a hydroxy group is also preferred. With respect to the number of a hydroxy group included in a structural unit, in terms of hydrophilicity of the water-insoluble resin and compatibility with other monomers and solvent used during polymerization, it is preferably 1 to 4, more preferably 1 to 3, and even more preferably 1 to 2, but not specifically limited thereto.

The content of the hydrophilic structural unit, for example, varies depending on the ratio of the hydrophobic structural unit (B) described below. For example, when the water-insoluble resin consists of acrylic acid and/or methacrylic acid [hydrophilic structural unit (A)] and the hydrophobic structural unit (B) described below, the content of acrylic acid and/or methacrylic acid is calculated by “100−(% by mass of the hydrophobic structural unit)”

A single type of the hydrophilic structural unit (A) can be used, or a combination of two or more types thereof can be used.

<Hydrophobic Structural Unit (B)>

The water-insoluble resin of the invention may further include, as another hydrophobic structural unit (B), a hydrophobic structural unit which is different from the structural unit represented by the formula (I). Examples of another hydrophobic structural unit include a structural unit that does not belong to the hydrophilic structural unit (A) (i.e., having no hydrophilic functional group) such as a structural unit derived from a vinyl monomer such as (meth)acrylates, (meth)acrylamides, styrenes, and vinyl esters, and a hydrophobic structural unit having an aromatic ring linked to an atom included in a main chain via a linking group. These structural units can be used alone or in combination of two or more.

Examples of the (meth)acrylates include methyl(meth)acrylate, ethyl(meth)acrylate, butyl(meth)acrylate, isobutyl(meth)acrylate, hexyl(meth)acrylate and the like. Among these, methyl(meth)acrylate, ethyl(meth)acrylate and butyl(meth)acrylate are preferred. Methyl(meth)acrylate and ethyl(meth)acrylate are particularly preferred.

Examples of the (meth)acrylamides include (meth)acrylamides such as N-cyclohexyl(meth)acrylamide, N-(2-methoxyethyl)(meth)acrylamide, N,N-diallyl(meth)acrylamide, or N-allyl(meth)acrylamide.

Examples of the styrenes include styrene, methylstyrene, dimethylstyrene, trimethylstyrene, ethylstyrene, isopropylstyrene, n-butylstyrene, tert-butylstyrene, methoxystyrene, butoxystyrene, acetoxystyrene, chlorostyrene, dichlorostyrene, bromostyrene, chloromethylstyrene, hydroxystyrene which is protected by a group removable with an acidic compound (for example, t-Boc and the like), methyl vinylbenzoate, αc-methylstyrene, vinyl naphthalene and the like. Among these, styrene and α-methylstyrene are preferred.

Examples of the vinyl esters include vinyl esters such as vinyl acetate, vinyl chloroacetate, vinyl propionate, vinyl butyrate, vinyl methoxyacetate or vinyl benzoate. Among these, vinyl acetate is preferred.

In the “hydrophobic structural unit which has an aromatic ring linked to an atom included in a main chain via a linking group”, the aromatic ring is linked to the atom included in the main chain of the water-insoluble resin via a linking group and thus not directly linked to the atom included in the main chain of the water-insoluble resin. As result, an appropriate distance is maintained between the hydrophobic aromatic ring and the hydrophilic structural unit, and an interaction between the water-insoluble resin and the pigment can easily occur, and the resin is strongly adsorbed to the pigment, so that the dispersibility can be further improved.

The “hydrophobic structural unit which has an aromatic ring linked to an atom included in the main chain via a linking group” may be a structural unit represented by the formula (II) described below (in which the structural unit represented by the formula (I) is not included).

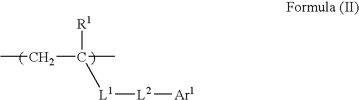

In the formula (II), R¹ represents a hydrogen atom, a methyl group, or a halogen atom.

L¹ represents *—COO—, *—OCO—, *—CONR²—, *—O—, or a substituted or unsubstituted phenylene group, R² represents a hydrogen atom, or an alkyl group having 1 to 10 carbon atoms. The symbol “*” for L¹ represents a position linked to the main chain. When the phenylene group is substituted, examples of a substituent include a halogen atom, an alkyl group, an alkoxy group, a hydroxy group, a cyano group and the like, but not limited thereto.

L² represents a single bond or a divalent linking group having 1 to 30 carbon atoms, and when it is a divalent linking group, it is preferably a linking group having 1 to 25 carbon atoms, more preferably a linking group having 1 to 20 carbon atoms, and still more preferably a linking group having 1 to 15 carbon atoms.

Among these, particularly preferred are an alkyleneoxy group having 1 to 25 carbon atoms (more preferably 1 to 10 carbon atoms), an imino group (—NH—), a sulfamoyl group, and a divalent linking group which includes an alkylene group such as an alkylene group having 1 to 20 carbon atoms (more preferably 1 to 15 carbon atoms) or an ethylene oxide group [—(CH₂CH₂O)ₙ—, n=1-6], and a group in which two or more of these groups are combined.

In the formula (II), Ar¹ represents a monovalent group derived from an aromatic ring.

The aromatic ring represented by Ar¹ is not specifically limited. Examples of the aromatic ring represented by Ar¹ include a benzene ring, a condensed aromatic ring having 8 or more carbon atoms, an aromatic ring in which a heterocycle is condensed, and two or more benzene rings that are connected to each other. Detailed information regarding the condensed aromatic ring having 8 or more carbon atoms and the aromatic ring in which a heterocycle is condensed is the same as described above.

Herein below, specific examples of a monomer which can form the hydrophobic structural unit (B) are given. However, according to the invention, it is not limited to the following specific examples.

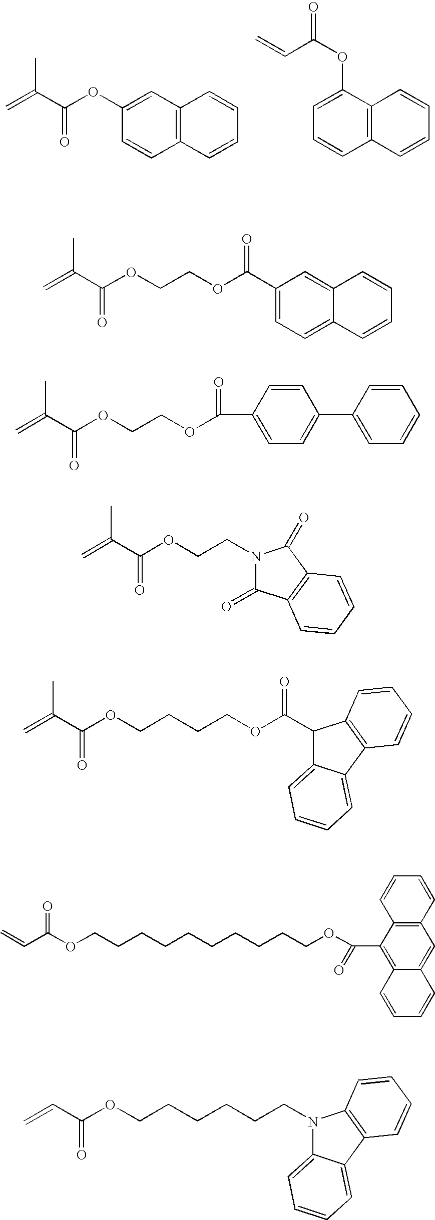

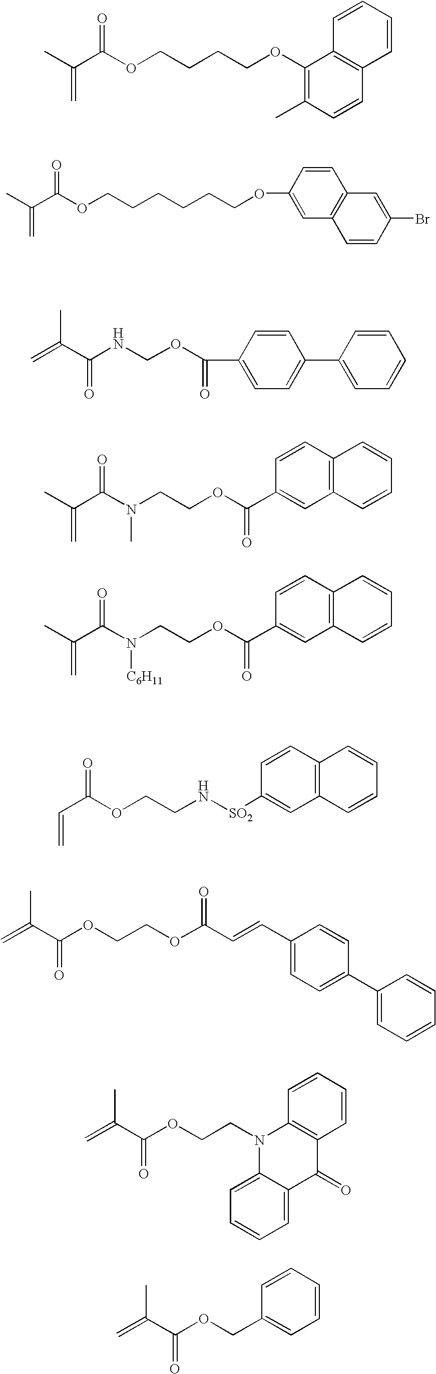

In the water-insoluble resin of the invention, although the composition ratio of the hydrophilic structural unit (A) and hydrophobic structural unit (B; including the structural unit represented by the formula (I)) varies depending on hydrophilicity and hydrophobicity of each units, it is preferred that the content of the hydrophilic structural unit (A) is 15% by mass or less. In this case, the content of the hydrophobic structural unit (B) is preferably more than 80% by mass, and more preferably 85% by mass or more with respect to the total mass of the water-insoluble resin.

When the hydrophilic structural unit (A) is included in an amount of 15% by mass or less, the amount of the component that is dissolved by itself in an aqueous liquid medium can be reduced, and various properties including dispersibility of the pigment can be improved. As a result, when inkjet recording is carried out, a favorable ink discharge property can be obtained.

The content of the hydrophilic structural unit (A) is preferably in the range of more than 0% by mass to 15% by mass, more preferably in the range of 2-15% by mass, still more preferably in the range of 5-15% by mass, and even still more preferably in the range of 8-12% by mass with respect to the total mass of the water-insoluble resin.

The content of aromatic rings included in the water-insoluble resin is preferably 27% by mass or less, more preferably 25% by mass or less, and still more preferably 20% by mass or less with respect to the total mass of the water-insoluble resin. Among these, the range of 15-20% by mass is preferred and the range of 17-20% by mass is more preferred. When the content of aromatic rings falls within the above range, resistance to scrubbing is improved.

Acid number of the water-insoluble resin of the invention is preferably 30 mg KOH/g or more but 100 mg KOH/g or less, in terms of dispersibility of the pigment and storage stability. More preferably, it is 30 mg KOH/g or more but 85 mg KOH/g or less. Even more preferably, it is 50 mg KOH/g or more but 85 mg KOH/g or less.

The acid number is defined as the mass (mg) of KOH that is required for complete neutralization of 1 g of the water-insoluble resin and is measured by the method according to JIS Standard (JIS K0070, 1992), the disclosure of which is incorporated by reference herein.

The weight average molecular weight (Mw) of the water-insoluble resin of the invention is preferably 30,000 or more, more preferably 30,000-150,000, still more preferably 30,000-100,000 and even still more preferably 30,000-80,000. In the case of the molecular weight of 30,000 or more, a steric repulsive effect for a dispersion agent tends to be improved, and due to such a steric effect, adsorption onto pigment can be improved.

In addition, the number average molecular weight (Mn) is preferably in the range of 1,000-100,000, and more preferably in the range of 3,000-50,000. When the number average molecular weight falls within the above range, function of the resin as a coating layer on the pigment or coating layer of an ink composition can be obtained. According to the invention, the water-insoluble resin is preferably used in a form of salt of an alkaline metal or an organic amine.

In addition, the molecular weight distribution of the water-insoluble resin of the invention (weight average molecular weight/number average molecular weight) is preferably in the range of 1 to 6, and more preferably in the range of 1 to 4. When the molecular weight distribution falls within the above range, dispersion stability and discharge stability of ink can be improved.

The number average molecular weight and weight average molecular weight are measured by gel permeation chromatography (GPC). As a GPC instrument, HLC-8020GPC (manufactured by Tosoh Corp.) is used, and three columns of TSKGEL, SUPER MULTIPORE HZ-H (manufactured by Tosoh Corp., 4.6 mmID×15 cm) were used. The detection was carried out using THF (tetrahydrofuran) as an eluent, and the molecular weight is calculated by a conversion with a polystyrene as a standard material. As a measurement condition, sample concentration is 0.35% by mass, flow rate is 0.35 ml/min, sample injection amount is 10 μl, and measurement temperature is 40° C., and an IR detector is used for detection. In addition, the calibration curve is established by using eight samples of “STANDARD SAMPLE TSK STANDARD, POLYSTYRENE” (manufactured by Tosoh Corp.): F-40, F-20, F-4, F-1, A-5000, A-2500, A-1000 and n-propylbenzene.

The water-insoluble resin of the invention can be polymerized according to various polymerization methods such as solution polymerization, precipitation polymerization, suspension polymerization, precipitation polymerization, bulk polymerization, or emulsion polymerization. The polymerization reaction can be carried out according to a known operational process such as a batch process, a semi-continuous process, a continuous process and the like. Examples of the method for initiating polymerization include a method using a radical initiator, a method using light or radiation and the like. These methods for polymerization and method for initiating polymerization are described in literatures; for example “Method for polymer synthesis” (revised edition, Tsuruta Teiji, 1971, Nikkan Kogyo Shimbun) or “Experimental method for polymer synthesis” (Otsu Takayuki and Kishita Masayoshi, 1972, Kagaku Dojin, pp 124-154).

Among the polymerization methods, a solution polymerization using a radical initiator is particularly preferred. Examples of a solvent which can be used for a solution polymerization include various organic solvents such as ethyl acetate, butyl acetate, acetone, methylethyl ketone, methylisobutyl ketone, cyclohexanone, tetrahydrofuran, dioxan, N,N-dimethylformamide, N,N-dimethylacetamide, benzene, toluene, acetonitrile, methylene chloride, chloroform, dichloroethane, methanol, ethanol, 1-propanol, 2-propanol, or 1-butanol. The solvent may be used alone or in combination of two or more. In addition, it can be used as a mixed solvent with water. It is necessary to set the temperature for polymerization considering molecular weight of a polymer to be produced, and types of an initiator and the like. In general, it is approximately 0° C.-100° C. Preferably, the polymerization is carried out under the temperature range of 50-100° C. The reaction pressure can be appropriately selected and it is generally 1-100 kg/cm², and more preferred is 1-30 kg/cm². The reaction time may be approximately 5-30 hours. The resin produced may be further purified by re-precipitation and the like.

Herein below, specific examples of a preferred water-insoluble resin of the invention are described. However, it is not limited thereto in the invention. Meanwhile, the values described at the bottom right side of the parentheses for B-11-B-13 indicate mass percentage (% by mass).

| | | |
|---|---|---|
| 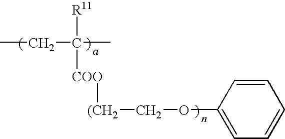 | 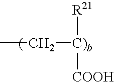 | 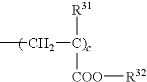 |

(a, b and c represent the respective composition ratios (% by mass))

| | R¹¹ | n | R²¹ | R³¹ | R³² | a | b | c | Mw |
|---|---|---|---|---|---|---|---|---|---|
| B-1 | CH₃ | 1 | CH₃ | CH₃ | —CH₃ | 60 | 9 | 31 | 35500 |
| B-2 | H | 1 | H | H | —CH₂CH₃ | 69 | 10 | 21 | 41200 |
| B-3 | CH₃ | 2 | CH₃ | CH₃ | —CH₃ | 70 | 11 | 19 | 68000 |
| B-4 | CH₃ | 4 | CH₃ | CH₃ | —CH(CH₃)CH₃ | 70 | 7 | 23 | 72000 |
| B-5 | H | 5 | H | H | —CH₃ | 70 | 10 | 20 | 86000 |
| B-6 | H | 5 | H | H | —CH₂CH(CH₃)CH₃ | 70 | 2 | 28 | 42000 |
| B-7 | CH₃ | 1 | CH₃ | CH₃ | —CH₂CH₃ | 50 | 11 | 39 | 44500 |
| B-8 | CH₃ | 1 | CH₃ | CH₃ | —CH₂CH₃ | 50 | 10 | 40 | 51200 |
| B-9 | H | 1 | H | H | —CH₂CH₃ | 45 | 11 | 44 | 48900 |
| B-10 | H | 1 | CH₃ | CH₃ | —CH₂CH₃ | 45 | 12 | 43 | 43600 |

| | | | | |
|---|---|---|---|---|
| B-11 | 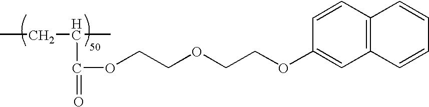 | 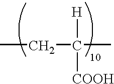 | 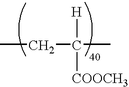 | 72400 |
| B-12 | 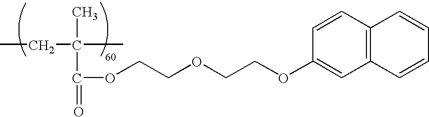 | 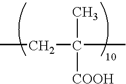 | 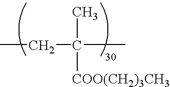 | 33800 |
| B-13 | 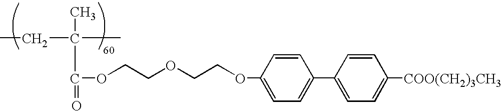 | 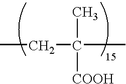 | 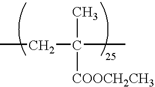 | 39200 |

<Carbon Black>

As the carbon black, a carbon black having a relatively large particle surface area, that is, a specific surface area of 200 m²/g or more but less than 300 m²/g according to a BET method, is used. The carbon black having a specific surface area in the above range has a relatively small particle diameter, and when it is used as a colorant, higher print density can be obtained. Further, when it is coated with the water-insoluble resin of the invention and included in an ink, favorable dispersibility and dispersion stability after a dispersion process can be obtained, so that a black colored ink having a stable ink discharge property can be obtained.

The specific surface area of carbon black is preferably in the range of 200 m²/g or more but less than 300 m²/g, and more preferably in the range of 200 m²/g or more but 280 m²/g or less in terms of print density and dispersibility.

The specific surface area in the invention indicates a specific surface area that is determined according to BET method. BET method is one type of a method for measuring surface area of powder by vapor phase adsorption. In this method, from an adsorption isotherm, a total surface area of one gram of a sample, i.e., a specific surface area, is measured. In general, nitrogen gas is mainly used as an absorption gas, and a method in which an adsorption amount is measured from the pressure or volume change of a gas that is being adsorbed is most commonly used. The most well-known formula for representing the isotherm of multimolecular adsorption was established by Brunauer, Emmett and Teller (so called, BET formula), and is widely used for determination of surface area. Based on BET formula, an adsorption amount is calculated, and then by multiplying it with surface area that is occupied by a single adsorption molecule, the surface area can be obtained.

Examples of carbon black include those produced by known methods such as a contact method, a furnace method, or a thermal method.

Specific examples of carbon black of the invention and other carbon black which may be also used include RAVEN7000, RAVEN5750, RAVEN5250, RAVEN5000 ULTRAII, RAVEN3500, RAVEN2000, RAVEN1500, RAVEN1250, RAVEN1200, RAVEN1190 ULTRAII, RAVEN1170, RAVEN1255, RAVEN1080, RAVEN1060, RAVEN700 (all manufactured by Colombian Carbon Corp.), REGAL400R, REGAL330R, REGAL660R, MOGUL L, BLACK PEARLS L, MONARCH700, MONARCH800, MONARCH880, MONARCH900, MONARCH1000, MONARCH1100, MONARCH1300, MONARCH1400 (all manufactured by Cabot Corp.), COLOR BLACK FW1, COLOR BLACK FW2, COLOR BLACK FW2V, COLOR BLACK 18, COLOR BLACK FW200, COLOR BLACK S150, COLOR BLACK S160, COLOR BLACK S170, PRINTEX 35, PRINTEX U, PRINTEX V, PRINTEX 140U, PRINTEX 140V, SPECIAL BLACK 6, SPECIAL BLACK 5, SPECIAL BLACK 4A, SPECIAL BLACK 4, NIPEX180-IQ, NIPEX170-IQ (all manufactured by Evonik Degussa Co., Ltd), and No. 25, No. 33, No. 40, No. 45, No. 47, No. 52, No. 900, No. 2200B, No. 2300, No. 990, No. 980, No. 970, No. 960, No. 950, No. 850, MCF-88, MA600, MA7, MA8, MA100 (all manufactured by Mitsubishi Chemical Corp.) and the like, but not limited thereto.

Carbon black can be used alone in single type or in combination of two or more different types.

The mass ratio between the carbon black (cb) and the water-insoluble resin (r) according to the invention (i.e., cb:r) is preferably 100:25-100:140. More preferably, it is 100:25-100:50. When the ratio (cb:r) is 100:25 or more, dispersion stability and resistance to scrubbing tend to be improved. When the ratio is 100:140 or less, dispersion stability tends to be improved.

The resin coated carbon black of the invention (encapsulated pigment) can be produced according to conventional physical and chemical methods using a water-insoluble resin and carbon black pigment, etc. For example, it can be produced according to the methods described in JP-A Nos. 9-151342, 10-140065, 11-209672, 11-172180, 10-25440 or 11-43636. Specifically, the phase inversion emulsification method and the acid precipitation method and the like that have been disclosed in JP-A Nos. 9-151342 and 10-140065 can be mentioned. Among these, in terms of dispersion stability, the phase inversion emulsification method is preferred.

a) Phase Inversion Emulsification Method

Phase inversion emulsification method is basically a self-dispersing (phase inversion emulsification) method which includes dispersing a mixed molten material including a resin having self-dispersing ability or solubility and a pigment in water. In addition, the mixed molten material may include a hardening agent or a polymer compound. The mixed molten material may be in a state of being not dissolved but mixed, a state of being dissolved and mixed, or a state including both of the two states. More specific examples of the “phase inversion emulsification method” include those described in JP-A No. 10-140065.

b) Acid Precipitation Method

Acid precipitation method includes steps of preparing a hydrous cake including a pigment and a resin, and neutralizing a part of or the whole anionic groups contained in the resin by using a basic compound to produce a microcapsulated pigment.

Specifically, an acid precipitation method may include steps of (1) dispersing the pigment and the resin in an alkaline aqueous medium, and optionally heat treating to carry out gelation of the resin, (2) adjusting the pH to a neutral or acidic value to obtain hydrophobic resin, and thereby strongly fixing the resin to the pigment, (3) optionally carrying out filtration and water washing to obtain a hydrous cake, (4) neutralizing a part of or the whole anionic groups contained in the resin of a hydrous cake by using a basic compound, and thereafter re-dispersing the resin in an aqueous medium, and (5) optionally carrying out heat treatment to carry out gelation of the resin.

More specific examples of the phase inversion emulsification method and acid precipitation method include those described in JP-A Nos. 9-151342 and 10-140065.

With respect to the aqueous ink composition of the invention, the resin coated carbon black can be obtained by using the water-insoluble resin which includes a structural unit represented by the formula (I) through a production process for preparing dispersion of resin coated carbon black which includes the following step (1) and step (2). In addition, the production of the aqueous ink composition according to the invention can be carried out by a method in which the dispersion of the resin coated carbon black obtained by the above described production process is mixed with water and an organic solvent to give an aqueous ink.

Step (1): A mixture which includes the water-insoluble resin having a structural unit represented by the formula (I), an organic solvent, a neutralizing agent, carbon black and water is dispersed by stirring, etc. to obtain a dispersion.

Step (2): The Organic Solvent is Removed from the Dispersion.

Method for stirring is not specifically limited. A mixing and stirring apparatus that is generally used, or if necessary, a disperser such as an ultrasonic disperser, a high pressure homogenizer and a bead mill can be used.

Preferred examples of an organic solvent include an alcohol solvent, a ketone solvent and an ether solvent. Examples of the alcohol solvent include isopropyl alcohol, n-butanol, t-butanol, ethanol and the like. Examples of the ketone solvent include acetone, methylethyl ketone, diethyl ketone, methylisobutyl ketone and the like. Examples of the ether solvent include dibutyl ether, dioxane and the like. Among these solvents, ketone solvent such as methylethyl ketone and alcohol solvent such as isopropyl alcohol are preferred. Methylethyl ketone is more preferred.

The neutralizing agent is used to neutralize part of or the whole dissociating group and to form an emulsified or a dispersed state in which the specific water-insoluble resin is stabilized in water. Detailed explanation regarding the neutralizing agent will be given below.

In the step (2), the organic solvent is distilled off from the dispersion obtained in the step (1) by reduced pressure distillation method, etc. and is transferred to an aqueous system, and as a result, dispersion of the resin coated carbon black wherein the surface of the carbon black particles is coated with the water-insoluble resin can be obtained. In the dispersion obtained accordingly, the organic solvent is substantially removed and the amount of the organic solvent included is preferably 0.2% by mass or less, and more preferably 0.1% by mass or less.

More specifically, the method may include steps of (1) mixing the water-insoluble resin having an anionic group or a solution in which the resin is dissolved in an organic solvent with a basic compound (i.e., neutralizing agent) for neutralization, (2) obtaining a suspension by mixing the resulting mixture with pigment, and dispersing the pigment using a disperser, etc. to obtain a pigment dispersion, and (3) removing the organic solvent, for example by distillation to coat the pigment with the specific water-insoluble resin having an anionic group and disperse them in an aqueous medium to obtain an aqueous dispersion.

In addition, more specifically, those disclosed in JP-A Nos. 11-2096722 and 11-172180 can be referenced.

According to the invention, the dispersing treatment can be carried out by using, for example, a ball mill, a roll mill, a bead mill, a high pressure homogenizer, a high speed stirring type disperser, an ultrasonic homogenizer and the like.

According to the invention, the content of carbon black coated with the water-insoluble resin is, in terms of the dispersion stability and the concentration of the aqueous ink composition, preferably 1-10% by mass, more preferably 2-8% by mass and even more preferably, 2-6% by mass.

—Organic Solvent—

The aqueous ink composition of the invention includes at least one organic solvent. The organic solvent can function as an anti-drying agent, a humectant or a penetration promoting agent. As an anti-drying agent, it is used for preventing clogging due to aggregate that is produced by deposition and drying of ink at discharge opening of a discharge nozzle. As an anti-drying agent or a humectant, a water soluble organic solvent having lower vapor pressure compared to water is preferred. In addition, as a penetration promoting agent, it is employed in order to increase the penetration ability of the ink to paper.

The organic solvent that is included in the aqueous ink composition of the invention can be selected appropriately from known organic solvents, considering the functional activity as an anti-drying agent, a humectant or a penetration promoting agent. In terms of compatibility with water, water soluble organic solvents are preferred.

Examples of the water soluble organic solvent include glycerin, 1,2,6-hexanetriol, trimethylol propane, ethylene glycol, propylene glycol, diethylene glycol, triethylene glycol, tetraethylene glycol, pentaethylene glycol, dipropylene glycol, alkane diols such as 2-butene-1,4-diol, 2-ethyl-1,3-hexane diol, 2-methyl-2,4-pentane diol, 1,2-octane diol, 1,2-hexane diol, 1,2-pentane diol, or 4-methyl-1,2-pentane diol (polyhydric alcohols); sugars such as glucose, mannose, fructose, ribose, xylose, arabinose, galactose, aldonic acid, glucitol, maltose, cellobiose, lactose, sucrose, trehalose, or maltotriose; sugar alcohols; hyaluronic acids; so called solid humectants including ureas and the like; alkyl alcohols having 1 to 4 carbon atoms such as ethanol, methanol, butanol, propanol, or isopropanol; glycol ethers such as ethylene glycolmonomethyl ether, ethylene glycolmonoethyl ether, ethylene glycolmonobutyl ether, ethylene glycolmonomethyl ether acetate, diethylene glycolmonomethyl ether, diethylene glycolmonoethyl ether, diethylene glycolmono-n-propyl ether, ethylene glycolmono-iso-propyl ether, diethylene glycolmono-iso-propyl ether, ethylene glycolmono-n-butyl ether, ethylene glycolmono-t-butyl ether, diethylene glycolmono-t-butyl ether, 1-methyl-1-methyoxy butanol, propylene glycolmonomethyl ether, propylene glycolmonoethyl ether, propylene glycolmono-t-butyl ether, propylene glycolmono-n-propyl ether, propylene glycolmono-iso-propyl ether, dipropylene glycolmonomethyl ether, dipropylene glycolmonoethyl ether, dipropylene glycolmono-n-propyl ether, dipropylene glycolmono-iso-propyl ether; 2-pyrrolidone, N-methyl-2-pyrrolidone, 1,3-dimethyl-2-imidazolidinone, formamide, acetamide, dimethyl sulfoxide, sorbitol, sorbitan, acetin, diacetin, triacetin, sulforane and the like. These can be used alone or in combination of two or more.

As an anti-drying agent or a humectant, polyhydric alcohols are useful. Examples thereof include glycerin, ethylene glycol, diethylene glycol, triethylene glycol, propylene glycol, dipropylene glycol, tripropylene glycol, 1,3-butane diol, 2,3-butane diol, 1,4-butane diol, 3-methyl-1,3-butane diol, 1,5-pentane diol, tetraethylene glycol, 1,6-hexane diol, 2-methyl-2,4-pentane diol, polyethylene glycol, 1,2,4-butanetriol, 1,2,6-hexanetriol and the like. These may be used alone or in combination of two or more.

As a penetration agent, polyol compounds are preferred. Examples of aliphatic diol include 2-ethyl-2-methyl-1,3-propane diol, 3,3-dimethyl-1,2-butane diol, 2,2-diethyl-1,3-propane diol, 2-methyl-2-propyl-1,3-propane diol, 2,4-dimethyl-2,4-pentane diol, 2,5-dimethyl-2,5-hexane diol, 5-hexen-1,2-diol, 2-ethyl-1,3-hexane diol and the like. Among these, preferred examples include 2-ethyl-1,3-hexane diol and 2,2,4-trimethyl-1,3-pentane diol.

The organic solvent can be used alone or in combination of two or more.

Content of the organic solvent is preferably in the range of 1-60% by mass, and more preferably 5-40% by mass in the aqueous ink composition.

—Water—

The aqueous ink composition of the invention includes water and the amount of water is not specifically limited. A preferred amount of water is 10-99% by mass. More preferred amount is 30-80% by mass, and still more preferred amount is 50-70% by mass.

—Neutralizing Agent—

The aqueous ink composition of the invention includes at least one type of a neutralizing agent. The neutralizing agent can neutralize an acidic group included in the water-insoluble resin when resin coated pigment particles are prepared. Preferably, it is used in an amount of 0.5-1.5 equilvalents with respect to the acid number of the resin. More preferably, it is in the range of 1-1.5 equilvalents.

Examples of the neutralizing agent include alcohol amines (for example, diethanol amine, triethanol amine, 2-amino-2-ethyl-1,3-propane diol and the like), hydroxides of an alkali metal (for example, lithium hydroxide, sodium hydroxide, potassium hydroxide and the like), ammonium hydroxides (for example, ammonium hydroxide and quaternary ammonium hydroxide), phosphonium hydroxides, alkali metal carbonates and the like. Among these, sodium hydroxide and potassium hydroxide are preferably used.

—Surfactant—

The aqueous ink composition of the invention preferably includes at least one surfactant. The surfactant is employed as an agent for controlling surface tension, and examples thereof include a non-ionic, a cationic, an anionic and a betaine type surfactant.

To achieve good discharge of droplets with an inkjet method, the surfactant is preferably included in an amount which can control the surface tension of the aqueous ink composition to be in the range of 20-60 mN/m. Especially, it is preferred to be included in an amount which can control the surface tension to be in the range of 20-45 mN/m. It is more preferred to be included in an amount which can control the surface tension to be in the range of 25-40 mN/m.

As the surfactant, a compound which has a structure including both hydrophilic part and hydrophobic part in the molecule can be effectively used. Further, any of an anionic surfactant, a cationic surfactant, an amphiphilic surfactant, and a non-ionic surfactant can be used.

Specific examples of an anionic surfactant include sodium dodecylbenzene sulfonate, sodium lauryl sulfate, sodium alkyldiphenyl ether disulfonate, sodium alkylnaphthalene sulfonate, sodium dialkylsulfosuccinate, sodium stearate, potassium oleate, sodium dioctylsulfosuccinate, sodium polyoxyethylenealkyl ether sulfate, sodium polyoxyethylenealkyl ether sulfate, sodium polyoxyethylenealkylphenyl ether sulfate, sodium dialkyl sulfosuccinate, sodium stearate, sodium oleate, sodium t-octylphenoxyethoxypolyethoxyethyl sulfate, and the like. It can be used alone or in combination of two or more.

Specific examples of a non-ionic surfactant include polyoxyethylenelauryl ether, polyoxyethylenoctylphenyl ether, polyoxyethyleneoleylphenyl ether, polyoxyethylenenonylphenyl ether, oxyethylene-oxypropylene block copolymer, t-octylphenoxyethylpolyethoxy ethanol, nonylphenoxyethylpolyethoxy ethanol and the like. It can be used alone or in combination of two or more.

Examples of a cationic surfactant include tetraalkyl ammonium salt, alkyl amine slat, benzalkonium salt, alkyl pyridium salt, imidazolium salt, and the like. Specifically, dihydroxy ethylstearyl amine, 2-heptadecenyl-hydroxyethyl imidazoline, lauryl dimethylbenzyl ammonium chloride, cetylpyridinium chloride, stearamide methylpyridum chloride and the like can be mentioned.

Content of the surfactant in the aqueous ink composition is not specifically limited. It is preferably 1% by mass or more, more preferably 1-10% by mass, and still more preferably 1-3% by mass.

—Others—

The aqueous ink composition of the invention may include, in addition to the above described components, other components such as a fine resin particle or a polymer latex, an UV absorbing agent, a fade preventing agent, a fungicide, an anti-corrosive agent, an anti-oxidant, an emulsification stabilizer, a preservative, an anti-foaming agent, a viscosity controlling agent, a dispersion stabilizer, a chelating agent and the like, if necessary.

Examples of the fine resin particles include particles of an acrylic resin, a vinyl acetate resin, a styrene-butadiene resin, a vinyl chloride resin, an acryl-styrene resin, a butadiene resin, a styrene resin, a cross linked acrylic resin, a cross linked styrene resin, a benzoguanamaine resin, a phenol resin, a silicone resin, an epoxy resin, a urethane resin, a paraffinic resin, or a fluorine-based resin or a polymer latex including them.

An acrylic resin, an acryl-styrene resin, a styrene resin, a cross linked acrylic resin, and a cross linked styrene resin can be mentioned as a preferred example.

Weight average molecular weight of the resin particles is preferably 10,000 or more but 200,000 or less. More preferably, it is 100,000 or more but 200,000 or less.

Average particle diameter of the fine resin particles is preferably in the range of 10 nm-1 μm. More preferably, it is in the range of 10-200 nm. Still more preferably, it is in the range of 20-100 nm. Particularly more preferably, it is in the range of 20-50 nm.

The addition amount of the fine resin particles is preferably 0.5-20% by mass with respect to the ink. More preferably, it is 3-20% by mass, and still more preferably it is 5-15% by mass.

Glass transition temperature (Tg) of the fine resin particles is preferably 30° C. or more. More preferably, it is 40° C. or more. Still more preferably, it is 50° C. or more.

The particle diameter distribution of polymer particles is not specifically limited and any one having broad particle diameter distribution or monodisperse particle diameter distribution may be used. Further, two or more kinds of polymer particles having monodisperse particle diameter distribution may be used as a mixture.

Examples of the UV absorbing agent include benzophenone type UV absorbing agent, benzotriazole type UV absorbing agent, salicylate type UV absorbing agent, cyanoacrylate type UV absorbing agent, nickel complex salt type UV absorbing agent, and the like.

As for the fade preventing agent, various types of organic or metal complex fade preventing agent can be used. Examples of the organic fade preventing agent include hydroquinones, alkoxypheonols, dialkoxyphenols, phenols, anilines, amines, indanes, chromanes, alkoxyanilines, heterocycles and the like. Examples of the metal complex include a nickel complex, a zinc complex and the like.

As for the fungicide, sodium dehydroacetate, sodium benzoate, sodium pyridinethion-1-oxide, p-hydroxybenzoic acid ethyl ester, 1,2-benzisothiazolin-3-one, sodium sorbate, sodium pentachlorophenolate and the like can be mentioned. The fungicide is preferably used in an amount of 0.02-1.00% by mass in the ink.

Examples of the anti-corrosive agent include acidic sulfite salt, sodium thiosulfate, ammonium thiodiglycolate, diisopropyl ammonium nitrite, pentaerythritol tetranitrate, dicyclohexyl ammonium nitrite and the like.

Examples of the anti-oxidant include phenol type anti-oxidant (including a hindered phenol type anti-oxidant), amine type anti-oxidant, sulfur type anti-oxidant, phosphorous type anti-oxidant and the like.

Examples of the chelating agent include sodium ethylenediamine tetraacetate, sodium nitrilotriacetate, sodium hydroxy ethylethylenediamine triacetate, sodium diethylene triamine pentaacetate, sodium uramyldiacetate and the like.

—Physical Properties of an Aqueous Ink Composition—

Surface tension of the aqueous ink composition according to the invention (at 25° C.) is preferably 20 mN/m or more but 60 mN/m or less. More preferably, it is 20 mN/m or more but 45 mN/m or less. Still more preferably, it is 25 mN/m or more but 40 mN/m or less.

The surface tension is measured by using AUTOMATIC SURFACE TENSIOMETER CBVP-Z (manufactured by Kyowa Interface Science Corp.) under the condition of testing the aqueous ink at 25° C.

In addition, the viscosity of the aqueous ink composition according to the invention at 20° C. is preferably 1.2 mPa·s or more but 15.0 mPa·s or less, more preferably 2 mPa·s or more but less than 13 mPa·s, and still more preferably 2.5 mPa·s or more but less than 10 mPa·s.

The viscosity is measured by using VISCOMETER TV-22 (manufactured by TOKI SANGYO CO. LTD) under the condition of testing the aqueous ink at 20° C.

The aqueous ink composition according to the invention can be used for forming a color image having multiple colors (e.g., full color image). For forming a full color image, an ink composition having magenta hue, an ink composition having cyan hue, and an ink composition having yellow hue, and optionally ink compositions having other hues including red (R), green (G), blue (B), white (W) or an ink composition having so called specific color in a printing field can be used.

—Recording Mode—

The aqueous ink composition of the invention can used in a recording mode in which an image is recorded on a recording medium by discharging with an inkjet method according to image information to be recorded (first recording mode).

Alternatively, the aqueous ink composition of the invention can also be used in a recording mode in which an aqueous liquid composition (i.e., a aggregating liquid), which includes a component capable of causing aggregation of pigment particles such as carbon black in an aqueous ink composition when admixed with it, is used so that an image is recorded by contacting the aqueous ink composition with the aqueous liquid composition (second recording mode).

—Aqueous Liquid Composition—

Herein below, the aqueous liquid composition that is used for the second recording mode will be explained.

The aqueous liquid composition includes an aggregating component which can cause aggregation of pigment contained in the aqueous ink composition when admixed with it, and if necessary, it may include further components.

—Aggregating Component—

The aqueous liquid composition includes at least one aggregating component which causes aggregation of pigment particles such as carbon black included in an aqueous ink composition. When the aqueous liquid composition is admixed with the aqueous ink composition that is discharged by an inkjet method, aggregation of the pigment, etc., stably dispersed in the aqueous ink composition, is promoted.

An example of the aqueous liquid composition includes a liquid composition which can cause an aggregate by changing pH of the aqueous ink composition. In this case, pH (at 25° C.) of the aqueous liquid composition is preferably 6 or less, and more preferably 4 or less. Among these, pH (at 25° C.) is in the range of 1 to 4, and more preferably in the range of 1 to 3. At the same time, pH (at 25° C.) of the aqueous ink composition is preferably 7.5 or more, and more preferably 8 or more.

In particular, in terms of image density, resolution and performing high speed inkjet recording, pH (at 25° C.) of the aqueous ink composition is preferably 7.5 or more, and pH (at 25° C.) of the aqueous liquid composition is preferably 4 or less.

Examples of aggregating components which cause aggregation of pigment particles such as carbon black include polyvalent metal salts, an organic acid, polyallylamine, and derivatives thereof, etc.

Preferred examples of the polyvalent metal salts include salts of an alkaline earth metal of Group 2 of the periodic table (for example, magnesium and calcium), a transition metal of Group 3 of the periodic table (for example, lanthanide), a cation of Group 13 of the periodic table (for example, aluminum), lanthanides (for example, neodymium) and the like. As a salt of these metals, carboxylic acid salt (formic acid, acetic acid, benzoic acid salt and the like), nitric acid salt, chlorides, and thiocyanic acid salt are preferred. Among these, more preferred are calcium salt or magnesium salt of a carboxylic acid (formic acid, acetic acid, benzoic acid salt and the like), calcium salt or magnesium salt of nitric acid, calcium chloride, magnesium chloride and calcium salt or magnesium salt of thiocyanic acid.

The organic acid is preferably selected from polyacrylic acid, acetic acid, glycolic acid, malonic acid, malic acid, maleic acid, ascorbic acid, succinic acid, glutaric acid, fumaric acid, citric acid, tartaric acid, lactic acid, sulfonic acid, orthophosphoric acid, pyrrolidone carboxylic acid, pyrone carboxylic acid, pyrrole carboxylic acid, furane carboxylic acid, pyridine carboxylic acid, coumarine acid, thiophen carboxylic acid, nicotinic acid, or derivatives of these compounds, or salts of them.

The aggregating components can be used alone or in combination of two or more.

The content of the aggregating components which cause the aggregation of a pigment, etc. is preferably 1-20% by mass, more preferably 5-20% by mass, and still more preferably 10-20% by mass in the aqueous liquid composition.

—Image Recording Method—

The aqueous ink composition of the invention can be used for any of the first recording mode or second recording mode.

In the first recording mode, an ink application step is included in which the black colored aqueous ink composition of the invention is applied on a recording medium according to an inkjet method.

In the second recording mode, an ink application step in which the black colored aqueous ink composition of the invention is applied on a recording medium according to an inkjet method, and an aggregating component application step in which the aqueous liquid composition including a component which causes aggregation of pigment particles, etc. such as carbon black and the like contained in the aqueous ink composition is applied on the recording medium are included, so that the aqueous ink composition and the aqueous liquid composition are brought into contact with each other to form an image.

In any of the first recording mode or second recording mode, the aqueous ink composition includes, as a colorant, a pigment coated with the water-insoluble resin of the invention in which a structural unit represented by the formula (I) is included. As a result, a black image with high color density can be obtained, and also failure in ink discharge directivity at the time of discharging ink is inhibited because adhesion or deposition of the aggregate at a head nozzle part is reduced and the adhered aggregate can be easily removed. As a result, the occurrence of an image problem such as white spots, etc. is inhibited, so that an image with high resolution can be obtained. Still further, frequency of maintenance of a discharge apparatus can be lowered and the maintainability can be improved.

In the ink application step, the aqueous ink composition is applied by an inkjet method. Specifically, to a medium to be recorded, i.e., a plain paper, a resin coated paper, for example paper for an inkjet printer as described in publications of JP-A Nos. 8-169172, 8-27693, 2-276670, 7-276789, 9-323475, 62-238783, 10-153989, 10-217473, 10-235995, 10-337947, 10-217597, 10-337947, a film, paper for electrophotography, cloth, glass, a metal, or a porcelain, the aqueous ink composition is discharged by energy supply to form a colored image. In addition, as a method for inkjet recording preferred for the invention, those disclosed in the paragraph Nos. 0093-0105 of JP-A No. 2003-306623 can be used.

Inkjet method is not specifically limited and may be any of known methods, for example, a charge control method which includes discharging ink using an electrostatic inducing force, drop on demand method (i.e., pressure pulse method) which utilizes vibration pressure of a piezoelectric element, a sonic inkjet method which includes discharging ink by using radiation pressure caused when the electric signal is converted into a sonic beam and radiated to the ink, or a thermal inkjet method (registered trademark; Bubblejet) which includes forming air bubbles by heating ink and using the pressure generated therefrom. As the inkjet method, the method which has been disclosed in JP-A No. 54-59936 and includes using a drastic volume change in ink by the action of heat energy, and discharging ink from a nozzle based on the working power generated from the change can be effectively used.

In addition, examples of the inkjet method include a method which includes discharging many times a small volume of the ink with low concentration (so called, photoink), a method which includes improving the quality of image by using multiple inks having the same color but with different concentration, or a method which includes using a colorless and transparent ink.

In addition, the inkjet head that is used for the inkjet method can be either on demand type or a continuous type. Further, specific examples of a discharging method include electromechanical transducer type (for example, single cavity type, double cavity type, bender type, piston type, share mode type, shared wall type and the like), electromechanical transducer type (for example, thermal inkjet type, Bubblejet type (registered trademark)), an electrostatic suction type (for example, electric field control type, slit jet type and the like) and a discharge type (for example, a spark jet type and the like) and the like. Any of these discharge methods can be used.

Further, the ink nozzle which is used for recording according to the inkjet method is not specifically limited. Rather, depending on the purpose of use, it can be appropriately selected.

In the aggregating component application step in the second recording mode, the aqueous liquid composition is applied on a recording medium either before or after the application of the aqueous ink composition. The application of the aqueous liquid composition can be carried out by a known method such as a coating method, an inkjet method or an dipping method. As a coating method, a known coating method using a bar coater, an extrusion die coater, an air doctor coater, a blade coater, a rod coater, a knife coater, a squeeze coater, a reverse roll coater, a bar coater and the like can be used. Specific details about an inkjet method are the same as those described above.

In the second recording mode of the invention, it is preferable that the aqueous liquid composition is applied first and then an ink application step is carried out. That is, in a preferred exemplary embodiment, before applying the aqueous ink composition to a recording medium, the aqueous liquid composition which causes aggregation of pigment included in the aqueous ink composition is applied, and thereafter, the aqueous ink composition is applied to be in contact with the aqueous liquid composition, which has been already applied to the recording medium, so as to form an image. In accordance with this, high speed inkjet recording can be performed, and an image with high density and high resolution can be obtained by the high speed recording.

When recording an image, a polymer latex compound may be also used for obtaining gloss or water resistance or improving weatherability. The period during which the polymer latex compound is applied may be any of before and after the application of the aqueous ink composition. Alternatively, they may be applied simultaneously. Thus, the polymer latex compound may be used in a mode in which it is applied to a recording medium, added to the aqueous ink composition, or provided as a separate liquid including the polymer latex compound.

Specifically, the methods that are disclosed in JP-A Nos. 2002-166638 (Japanese Patent Application No. 2000-363090), 2002-121440 (Japanese Patent Application No. 2000-315231), 2002-154201 (Japanese Patent Application No. 2000-354380), 2002-144696 (Japanese Patent Application No. 2000-343944), and 2002-080759 (Japanese Patent Application No. 2000-268952) can be preferably used.

The method for recording an image according to the invention may include an additional step in addition to the step for ink application and step for applying aggregating component. Additional step is not specifically limited and can be appropriately selected depending on a specific purpose. For example, drying and removing an organic solvent that is included in the aqueous ink composition applied to a recording medium, melt-fixing a polymer latex or fine resin particles included in the aqueous ink composition, and the like can be mentioned.

Another example of a method for recording an image of the invention involves using an intermediate transfer body as a recording medium to which an image is first formed, recording an image on the intermediate transfer body, and then transferring the image recorded on the intermediate transfer body to the medium to be recorded.

In case of the second recording mode, an exemplary method may include an ink application step in which an intermediate transfer body is used as a recording medium to which an image is first formed and to this intermediate transfer body the aqueous ink composition of the invention described before is applied by an inkjet method, a step for applying aggregating component in which an aqueous liquid composition including component that can cause aggregation of the pigment included in the aqueous ink composition is applied to the intermediate transfer body so that an image is formed on the intermediate transfer body by contacting the aqueous ink composition with the aqueous liquid composition, and a transfer step in which the image formed on the intermediate transfer body is transferred to a final recording medium.

In this case, same as described above, other steps such as a drying and removing process, a heating and fixing process and the like can be further included. The step for application of aggregating component is preferably carried out before the ink application step.

According to the invention, the following exemplary embodiments 1-6 are provided.

<1> An aqueous ink composition comprising a carbon black having a specific surface area of 200 m²/g or more but less than 300 m²/g according to a BET method, an organic solvent, a neutralizing agent and water, wherein the carbon black is coated with a water-insoluble resin comprising a structural unit represented by the following formula (I):

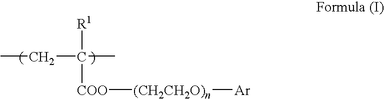

wherein R¹ represents a hydrogen atom or a methyl group, Ar represents an unsubstituted or substituted aromatic ring, and n represents an average repeating number and is from 1 to 6.

<2> The aqueous ink composition of <1>, wherein the aromatic ring represented by Ar in the formula (I) is an unsubstituted or substituted benzene ring.

<3> The aqueous ink composition of <1>, wherein

the water-insoluble resin comprises a hydrophilic structural unit (A) and a hydrophobic structural unit (B),

the content of aromatic rings in the water-insoluble resin is 20% by mass or less of the total mass of the water-insoluble resin,

the hydrophobic structural unit (B) includes the structural unit represented by the formula (I),

the content of the hydrophilic structural unit (A) in the water-insoluble resin is 15% by mass or less of the total mass of the water-insoluble resin, and

the hydrophilic structural unit (A) includes a structural unit derived from (meth)acrylic acid.

<4> The aqueous ink composition of <1>, wherein the acid value of the water-insoluble resin is 30 mgKOH/g or more but 100 mgKOH/g or less.

<5> The aqueous ink composition of <1>, wherein the carbon black is coated with the water-insoluble resin comprising a structural unit represented by the formula (I) according to a phase inversion emulsification method.

<6> The aqueous ink composition of <1>, further comprising a surfactant.

Consequently, according to the invention, an aqueous ink composition which may have high print density and excellent discharge stability and may inhibit image problems such as white spots can be provided.

### EXAMPLES

Herein below, the invention is explained in greater detail in view of the following Examples. However, the invention is not limited to the following Examples. In addition, unless specifically mentioned otherwise, the term “part” is based on the mass.

Further, weight average molecular weight was measured by gel permeation chromatography (GPC). As a GPC instrument, HLC-8020GPC (manufactured by Tosoh Corp.) is used and three columns of TSKGEL, SUPER MULTIPORE HZ-H (manufactured by Tosoh Corp., 4.6 mmID×15 cm) were used. In addition, THF (tetrahydrofuran) was used as an eluent. As a measurement condition, sample concentration is 0.35% by mass, flow rate is 0.35 ml/min, sample injection amount is 10 μl, and measurement temperature is 40° C., and an IR detector is used for detection. In addition, the calibration curve is established by using eight samples of “STANDARD SAMPLE TSK STANDARD, POLYSTYRENE”(manufactured by Tosoh Corp.): F-40, F-20, F-4, F-1, A-5000, A-2500, A-1000 and n-propylbenzene.

### Synthetic Example 1

—Synthesis of a Resin Dispersing Agent P-1—

To a 1,000 ml three-neck flask which is equipped with a stirrer and a condenser, methylethyl ketone (88 g) was added and then heated at 72° C. under nitrogen atmosphere. To the mixture, a solution in which 0.85 g of dimethyl-2,2′-azobisisobutyrate, 70 g of phenoxyethylmethacrylate, 10 g of methacrylic acid and 20 g of methylmethacrylate 20 g were dissolved in 50 g of methylethyl ketone was added dropwise over three hours. After completing the dropwise addition, the reaction was allowed to proceed for additional one hour. Then, a solution in which 0.42 g of dimethyl-2,2′-azobisisobutyrate is dissolved in 2 g of methylethyl ketone was added thereto, the temperature was raised to 78° C. and heated for four hours. The resulting reaction solution was re-precipitated twice in an excess amount of hexane, and the precipitated resin was dried to obtain 96.5 g of phenoxyethylmethacrylate/methylmethacrylate/methacrylic acid (copolymerization ratio [molar ratio]=70/20/10) copolymer (resin dispersing agent P-1).

Composition of thus obtained resin dispersing agent P-1 was confirmed with ¹H-NMR. The weight average molecular weight (Mw) measured with GPC was 43,500. In addition, the acid number of the polymer was found to be 65.2 mgKOH/g according to the measurement based on the method described in JIS Standard (JIS K 0070:1992).

—Synthesis of a Resin Dispersing Agent P-2 to P-4—

Except that phenoxyethylmethacrylate 70 g, methacrylic acid 10 g, and methylmethacrylate 20 g for the synthesis of the resin dispersing agent P-1 were changed to the monomers shown in Table 1, resin dispersing agents P-2 to P-4 were synthesized in almost the same manner as the synthesis of a resin dispersing agent P-1.

### Example 1

—Preparation of Dispersion C1 including Resin Coated Carbon Black Particles—

10 parts of carbon black NIPEX180-IQ (specific surface area according to BET method: 260 m²/g, manufactured by Evonik Degussa Corp.), 3 parts of the phenoxyethylmethacrylate/methylmethacrylate/methacrylic acid copolymer (resin dispersing agent P-1), 32 parts of methylethyl ketone, 4.2 parts of IN NaOH aqueous solution, and 100.8 parts of ion exchange water were mixed, and then dispersed for 2 to 6 hours by using 0.1 mmφ zirconia beads with a bead mill. Subsequently, methylethyl ketone was removed from thus obtained dispersion under reduced pressure at 55° C. and water was further removed. As a result, dispersion C1 including resin coated carbon black particles, wherein carbon black is included in concentration of 10.2% by mass, was prepared.

—Measurement of Particle Diameter of the Resin Coated Carbon Black Particles—

For the obtained dispersion C1 including resin coated carbon black particles, volume average particle diameter was measured based on a dynamic light scattering method using Nanotrac particle size analyzer (trade name: UPA-EX150, manufactured by Nikkiso Corp.). A sample liquid for measurement was prepared by adding 10 ml of ion exchange water to 30 μl of dispersion including resin coated carbon black particles, the temperature of the resulting sample liquid was adjusted to be 25° C., and the measurement was carried out. The measurement results are summarized in the following Table 1.

—Preparation of Aqueous Ink C1—

Next, by using the dispersion C1 including resin coated carbon black particles obtained from the above, aqueous ink C1 was prepared so as to have the composition described below. pH of the aqueous ink C1 was 9.0 at 25° C.

<Composition of Aqueous Ink C1>
dispersion C1 including the resin coated carbon black particles . . . 39.2 parts
glycerin . . . 15 parts
diethyleneglycolmonoethyl ether . . . 10 parts
OLFIN E 1010 (manufactured by Nissin Chemical Industry Co., Ltd.) . . . 1 part
ion exchange water . . . 34.8 parts

—Evaluation—

The dispersion C1 including the resin coated carbon black particles and the aqueous ink C1 obtained from the above were subjected to a measurement and evaluation as follows. The measurement and evaluation results are summarized in the following Table 1.

(Dispersion Stability)

The dispersion C1 including resin coated carbon black particles and the aqueous ink C1 obtained by using the same were evaluated according to the evaluation criteria described in the below.

<Evaluation Criteria>

A: An aqueous dispersion wherein pigment particles had a volume average particle diameter of 160 nm or less was obtained, the particle diameter change after an aqueous ink was prepared was 10 nm or less, and the particle diameter change after being kept at room temperature for seven days was 10 nm or less, and therefore a stable dispersion state was successfully maintained.

B: an aqueous dispersion or aqueous ink which satisfies the condition A was not obtained.

(Discharge Stability)

An inkjet apparatus equipped with an experimental print head with 600 dpi and 256 nozzles was provided, and charged with the obtained aqueous ink C1. The aqueous ink was discharged from the head to art paper (manufactured by Mitsubishi Paper Mill Limited) for 30 minutes. After that, as a maintenance process, pressure of 15 Kpa was applied for ten seconds, wiping was carried out using CLEAN WIPER FF-390c (manufactured by Kurary Co.), and then the discharge was continued again for five minutes. Five minutes later, the image recorded on the art paper (5 cm×5 cm) was observed. The observed image was evaluated with naked eyes according to the following evaluation criteria.

<Evaluation Criteria>

A: Image deformation due to the occurrence of white spots or the like was not observed.

B: There were many image problems such as the occurrence of white spots and image deformation was found.

(Print Density)

An inkjet apparatus equipped with an experimental print head with 600 dpi and 256 nozzles was provided, and charged with the obtained aqueous ink C1. The ink was discharged to art paper (manufactured by Mitsubishi Paper Mill Limited) to form a solid image. Optical density (OD) of this solid image was measured by using SPECTRO EYE (manufactured by Kimoto Co., Ltd.) and then evaluated according to the following evaluation criteria.

<Evaluation Criteria>

A: OD≧1.65

B: OD<1.65

### Example 2

A dispersion including resin coated carbon black particles was obtained, and measurement of particle diameter, preparation of an aqueous ink, and evaluation were carried out, in the same manner as in Example 1, except that carbon black of Example 1 was replaced with NIPEX 170-IQ (specific surface area according to BET method: 200 m²/g, manufactured by Evonik Degussa Corp.). The results of measurement and evaluation are summarized in the following Table 1.

### Example 3 to 5

A dispersion including resin coated carbon black particles was obtained, and measurement of particle diameter, preparation of an aqueous ink, and evaluation were carried out, in the same manner as in Example 1, except that the phenoxyethylmethacrylate/methylmethacrylate/methacrylic acid copolymer which had been used for production of the dispersion C1 including resin coated carbon black particles (i.e., resin dispersing agent P-1) was changed to the resin dispersing agent P-2 to P-4, respectively, as shown in Table 1 below, and 4.6 parts of 1N NaOH aqueous solution was used and ion exchange water was decreased by 0.4 parts when a dispersion was prepared using the resin dispersing agent P-2, and 4.9 parts of 1N NaOH aqueous solution was used and ion exchange water was decreased by 0.7 parts when a dispersion was prepared using the resin dispersing agent P-3 or P-4. The results of measurement and evaluation are summarized in the following Table 1.

### Comparative Examples 1 to 2

A dispersion including resin coated carbon black particles was obtained, and measurement of particle diameter, preparation of an aqueous ink, and evaluation were carried out, in the same manner as in Example 1, except that the phenoxyethylmethacrylate/methylmethacrylate/methacrylic acid copolymer which had been used for production of the dispersion including resin coated carbon black particles (i.e., resin dispersing agent P-1) was changed to benzylmethacrylate/methacrylic acid (=90/10 [% by mass]) copolymer (Comparative example 1) or benzylmethacrylate/methacrylic acid (=80/20 [% by mass]) copolymer (Comparative example 2), and 7.7 parts of 1N NaOH aqueous solution was used and ion exchange water was decreased by 3.5 parts when a dispersion was prepared using the benzylmethacrylate/methacrylic acid (=80/20 [% by mass]) copolymer (Comparative example 2). The results of measurement and evaluation are summarized in the following Table 1.

### Comparative Example 3

A dispersion including resin coated carbon black particles was obtained, and measurement of particle diameter, preparation of an aqueous ink, and evaluation were carried out, in the same manner as in Example 1, except that carbon black of Example 1 was replaced with COLOR BLACK FW200 (specific surface area according to BET method: 460 m²/g, manufactured by Evonik Degussa Corp.). The results of measurement and evaluation are summarized in the following Table 1.

### Comparative Example 4

A dispersion including resin coated carbon black particles was obtained, and measurement of particle diameter, preparation of an aqueous ink, and evaluation were carried out, in the same manner as in Example 1, except that carbon black of Example 1 was replaced with SPECIAL BLACK 6 (specific surface area according to BET method: 300 m²/g, manufactured by Evonik Degussa Corp.). The results of measurement and evaluation are summarized in the following Table 1.

### Comparative Example 5

A dispersion including resin coated carbon black particles was obtained, and measurement of particle diameter, preparation of an aqueous ink, and evaluation were carried out, in the same manner as in Example 1, except that carbon black of Example 1 was replaced with NIPEX160-IQ (specific surface area according to BET method: 150 m²/g, manufactured by Evonik Degussa Corp.). The results of measurement and evaluation are summarized in the following Table 1.

### Comparative Example 6

A dispersion including resin coated carbon black particles was obtained, and measurement of particle diameter, preparation of an aqueous ink, and evaluation were carried out, in the same manner as in Example 1, except that carbon black of Example 1 was replaced with SPECIAL BLACK 4 (specific surface area according to BET method: 180 m²/g, manufactured by Evonik Degussa Corp.). The results of measurement and evaluation are summarized in the following Table 1.

TABLE 1

| | Water-insoluble resin | | | | Carbon black | Particle | | | |
|---|---|---|---|---|---|---|---|---|---|
| | | | Weight | Acid | Specific | diameter | | | |
| | | | average | number | surface area | of | | | |
| | | | molecular | [mgKO | according to | dispersion | Dispersion | Discharge | |
| | | Type (% by mass) | weight | H/g] | BET method | [nm] | stability | stability | Blackness |
| Example 1 | P-1 | phenoxyethylmethacrylate/methylmethacrylate/ | 43500 | 65.2 | 260 | 130 | A | A | A |
| | | methacrylic acid copolymer (=70/20/10) | | | | | | | |
| Example 2 | P-1 | phenoxyethylmethacrylate/methylmethacrylate/ | 45300 | 65.2 | 200 | 125 | A | A | A |
| | | methacrylic acid copolymer (=70/20/10) | | | | | | | |
| Example 3 | P-2 | phenoxyethylmethacrylate/ethylmethacrylate/ | 48200 | 71.72 | 260 | 128 | A | A | A |
| | | methacrylic acid copolymer (=50/39/11) | | | | | | | |
| Example 4 | P-3 | phenoxyethylacrylate/ethylacrylate/acrylic acid | 38900 | 77.9 | 260 | 135 | A | A | A |
| | | copolymer (=45/45/10) | | | | | | | |
| Example 5 | P-4 | phenoxyethylmethacrylate/structure A/ | 41500 | 78.24 | 260 | 125 | A | A | A |
| | | ethylmethacrylate/methacrylic acid copolymer | | | | | | | |
| | | (=50/5/33/12) | | | | | | | |
| Comparative | benzylmethacrylate/methacrylic acid copolymer | | 47000 | 65.2 | 260 | 135 | A | B | A |
| Example 1 | (=90/10) | | | | | | | | |
| Comparative | benzylmethacrylate/methacrylic acid copolymer | | 46500 | 130.4 | 260 | 137 | A | B | A |
| Example 2 | (=80/20) | | | | | | | | |
| Comparative | P-1 | phenoxyethylmethacrylate/methylmethacrylate/ | 43500 | 65.2 | 460 | Impossible | B | Impossible | Impossible |
| Example 3 | | methacrylic acid copolymer (=70/20/10) | | | | to disperse | | to evaluate | to evaluate |
| Comparative | P-1 | phenoxyethylmethacrylate/methylmethacrylate/ | 43500 | 65.2 | 300 | Impossible | B | Impossible | Impossible |
| Example 4 | | methacrylic acid copolymer (=70/20/10) | | | | to disperse | | to evaluate | to evaluate |
| Comparative | P-1 | phenoxyethylmethacrylate/methylmethacrylate/ | 43500 | 65.2 | 150 | 125 | A | A | B |
| Example 5 | | methacrylic acid copolymer (=70/20/10) | | | | | | | |
| Comparative | P-1 | phenoxyethylmethacrylate/methylmethacrylate/ | 43500 | 65.2 | 180 | 170 | B | B | B |
| Example 6 | | methacrylic acid copolymer (=70/20/10) | | | | | | | |

Structure A

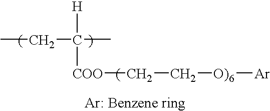

As shown in the Table 1, according to the Examples of the invention, good dispersibility was obtained, and the dispersibility was stable even after the ink composition was prepared. Further, when recording an image, stable discharge of the ink composition was possible, and an image with high density was obtained. Further, failure in discharge directivity due to the adhesion of the aggregate on a head was inhibited, and the occurrence of white spots in recorded image was also inhibited. Still further, the adhesion amount of the aggregate formed by the occurrence of mist was small, and the adhered aggregate could be easily removed, and therefore the maintenance was reduced and simplified.

On the other hand, in the Comparative examples, the image density was not sufficient, and the adhesion of the aggregate on the head was so severe that the occurrence of failure in discharge directivity of discharged ink could not be prevented and also the occurrence of white spots could not be prevented.

All publications, patent applications, and technical standards mentioned in this specification are herein incorporated by reference to the same extent as if each individual publication, patent application, or technical standard was specifically and individually indicated to be incorporated by reference.

What is claimed is:

1. An aqueous ink composition comprising a carbon black having a specific surface area of 200 m²/g or more but less than 300 m²/g according to a BET method, an organic solvent, a neutralizing agent and water, wherein the carbon black is coated with a water-insoluble resin comprising a structural unit represented by the following formula (I): 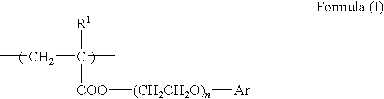
wherein R¹ represents a hydrogen atom or a methyl group, Ar represents an unsubstituted or substituted aromatic ring, and n represents an average repeating number and is from 1 to 6.

2. The aqueous ink composition of claim 1, wherein the aromatic ring represented by Ar in the formula (I) is an unsubstituted or substituted benzene ring.

3. The aqueous ink composition of claim 1, wherein
the water-insoluble resin comprises a hydrophilic structural unit (A) and a hydrophobic structural unit (B),
the content of aromatic rings in the water-insoluble resin is 20% by mass or less of the total mass of the water-insoluble resin,
the hydrophobic structural unit (B) includes the structural unit represented by the formula (I),
the content of the hydrophilic structural unit (A) in the water-insoluble resin is 15% by mass or less of the total mass of the water-insoluble resin, and
the hydrophilic structural unit (A) includes a structural unit derived from (meth)acrylic acid.

4. The aqueous ink composition of claim 1, wherein the acid value of the water-insoluble resin is 30 mgKOH/g or more but 100 mgKOH/g or less.

5. The aqueous ink composition of claim 1, wherein the carbon black is coated with the water-insoluble resin comprising a structural unit represented by the formula (I) according to a phase inversion emulsification method.

6. The aqueous ink composition of claim 1, further comprising a surfactant.
